(19) United States
(12) Patent Application Publication
(10) Pub. No.: US 2026/0115770 A1
(43) Pub. Date: Apr. 30, 2026

(54) HANDHELD DRAIN CLEANER

(71) Applicant: Emerson Professional Tools, LLC, Elyria, OH (US)

(72) Inventors: Jacob Schneider, Elyria, OH (US); Sachin S. Dakare, Pune (IN); Rahul Maruti Nanche, Kolhapur (IN); Harald Krondorfer, Aurora, OH (US); Michael J. Rutkowski, North Royalton, OH (US)

(73) Assignee: Emerson Professional Tools, LLC, Elyria, OH (US)

(21) Appl. No.: 19/052,963

(22) Filed: Feb. 13, 2025

(30) Foreign Application Priority Data
Oct. 28, 2024 (IN) 202421082368

(51) Int. Cl. B08B 9/043; E03C 1/302

(52) U.S. Cl. CPC B08B 9/0436; E03C 1/302

(57) ABSTRACT

A handheld drain cleaner which feeds out and retracts a flexible cable for use in cleaning a drain includes a housing, a rotatable drum and a feed clutch assembly coupled thereto, and a driving assembly provided on the drum and within the housing. The housing has a cavity, a rear opening and a front opening. First and second axes parallel, but offset axes, are defined through the centers of the openings. The drum is rotatable about the first axis. The driving assembly is engageable with the flexible cable upon movement of the feed clutch assembly to feed the cable out of, or into, the drum, along a feed path upon engagement of the feed clutch assembly with the driving assembly and rotation of the drum.

### FIELD OF THE DISCLOSURE

The present disclosure generally relates to a handheld drain cleaner with a cable feeding and retraction assembly.

### BACKGROUND

Drain cleaners are used to clean drain lines from ¾″ up to 2″ in diameter from everyday clogs in kitchens, bathrooms and more. A flexible cable is positively retained in a drum of the drain cleaner. An actuator member is actuated and the drum is rotated to feed the flexible cable out of the drain cleaner to clean the drain line.

U.S. Pat. No. 8,826,483 provides a drain cleaner which includes an auto-feeding mechanism which allows the cable to self-feed down the drain. Because of the mechanisms of this drain cleaner, it takes a substantial amount of time (more than 6.5 minutes) to completely feed the cable out of the drain cleaner and to completely retract the cable into the drain cleaner. The cable advancement is slow with one revolution of the drum and takes more than 650 revolutions to completely feed a twenty-five foot long cable.

Improvements to the structure of drain cleaners is desirable.

### SUMMARY

In an embodiment, a handheld drain cleaner which feeds out and retracts a flexible cable for use in cleaning a drain includes a housing, a drum coupled to the housing, a feed clutch assembly connected to the housing for selectively engaging the flexible cable within a cavity in the housing, and a driving assembly provided on the drum and within the housing. The housing defines a cavity and has a rear opening and a front opening extending from the cavity. A center of the rear opening defines a first axis and a center of the front opening defines a second axis. The first and second axes are parallel to each other and offset from each other, with the second axis being offset vertically below the first axis. The drum is rotatable relative to the housing about the first axis. The driving assembly is engageable with the flexible cable upon movement of the feed clutch assembly. A feed path is defined through the rear opening, between the feed clutch assembly and the driving assembly and through the front opening. The flexible cable can be feed out of the drum, along the feed path and out of the housing upon engagement of the feed clutch assembly with the driving assembly and rotation of the drum in a first direction, and the flexible cable can be feed into the drum along the feed path upon engagement of the feed clutch assembly with the driving assembly and rotation of the drum in a second, opposite direction.

The drum may include a conical front end wall, a side wall extending rearwardly therefrom, and a rear end wall which define a drum cavity. An opening is provided through a center of the conical front end wall through which the flexible cable exits or enters the drum cavity.

In a first embodiment, the driving assembly includes a first gear extending from the front end of the drum, and a second gear extending from the shaft, the first and second gears being coupled together. The drum includes an elongated shaft extending from the conical front end wall on which the first gear is provided, and the cable passes through a passageway formed by the elongated shaft. Each gear may be a bevel gear or a face gear, and the first gear and the elongated shaft may be integrally formed.

In a second embodiment, the driving assembly includes a first gear extending from the front end of the drum, a second gear rotatably mounted on the housing, and a third gear rotatably mounted on the housing. The shaft extends from the third gear. The first and second gears are coupled together, and the second and third gears are coupled together. The drum may include an elongated shaft extending from the conical front end wall on which the first gear is provided, and the cable passes through a passageway formed by the elongated shaft. The first gear may be a bevel gear or a face gear, the second gear may be a combination gear including a bevel gear or face gear, and a spur gear, and the third gear may be a spur gear. The first gear and the elongated shaft may be integrally formed.

The feed clutch assembly includes a depressible actuator member which is pivotally attached to the housing, and a pinch roller rotatably mounted on the actuator member. The actuator member is depressed into an actuating position to move the pinch roller proximate to the driving assembly to pinch the cable between the pinch roller and the driving assembly.

The actuator member passes through an opening in the housing and blocks access into an interior of the housing in the actuating position and in the non-actuating position.

In an embodiment, the feed clutch assembly includes a spring element coupled to the housing and the actuator member which biases the actuator member to a non-actuating position wherein the pinch roller is distant from the driving assembly such that the cable is not pinched between the pinch roller and the driving assembly.

The driving assembly includes a drive wheel rotatably mounted on the housing and which has a rotational axis which is longitudinally aligned with the first axis, and the pinch roller is rearward of the drive wheel when in the non-actuating position. The pinch roller is below the second axis. The rotational axes of the drive wheel and pinch roller are normal to the first and second axes.

The pinch roller may be a smooth cylindrical roller and the drive wheel may have a contoured groove into which the cable seats. The contoured groove may take the form of a trapezoid, a V-shaped seat, a semi-circular seat, for example. The contoured seat may have texturing thereon.

The housing may have frangible housing wall sections extending into the front opening which are broken upon first use of the drain cleaner.

### BRIEF DESCRIPTION OF THE DRAWINGS

The organization and manner of the structure and operation of the disclosed embodiments, together with further objects and advantages thereof, may best be understood by reference to the following description, taken in connection with the accompanying drawings, which are not necessarily drawn to scale, wherein like reference numerals identify like elements in which:

FIG. 1 is a perspective view of a handheld drain cleaner of the present disclosure according to a first embodiment;

FIG. 2 is an exploded perspective view of the handheld drain cleaner;

FIG. 3 is a rear plan view of a portion of the handheld drain cleaner;

FIG. 4 is a cross-sectional view of the handheld drain cleaner in a non-actuating position taken along a longitudinal axis of the drain cleaner;

FIG. 4A is a partial cross-sectional view of the handheld drain cleaner in the non-actuating position taken along the longitudinal axis of the drain cleaner;

FIG. 5 is a cross-sectional view of the handheld drain cleaner in an actuating position taken along the longitudinal axis;

FIG. 5A is a partial cross-sectional view of the handheld drain cleaner in the actuating position taken along the longitudinal axis of the drain cleaner;

FIG. 6 is a further cross-sectional view of the handheld drain cleaner taken along a direction normal to the longitudinal axis;

FIG. 7 is a perspective view of a handheld drain cleaner of the present disclosure according to a second embodiment;

FIG. 8 is an exploded perspective view of the handheld drain cleaner of FIG. 7;

FIG. 9 is a cross-sectional view of the handheld drain cleaner of FIG. 7 in an actuating position taken along a direction normal to a longitudinal axis of the drain cleaner; and

FIG. 10 is a perspective view of an alternate gearing arrangement that can be used in the embodiments of the drain cleaner.

### DETAILED DESCRIPTION

While the disclosure may be susceptible to embodiment in different forms, there is shown in the drawings, and herein will be described in detail, specific embodiments with the understanding that the present disclosure is to be considered an exemplification of the principles of the disclosure, and is not intended to limit the disclosure to that as illustrated and described herein. Therefore, unless otherwise noted, features disclosed herein may be combined together to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

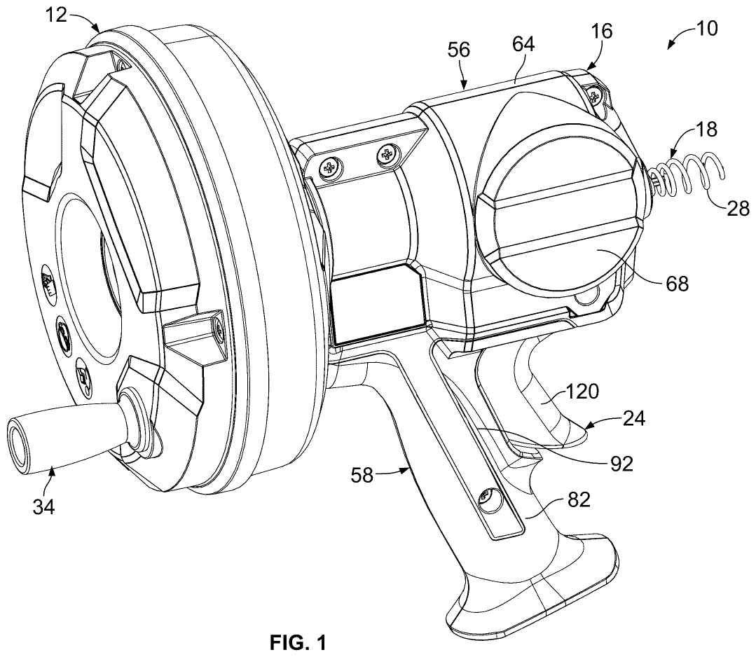

FIGS. 1-6 illustrate a handheld drain auger or cleaner 10 for cleaning a drain or sewer line. The drain cleaner 10 may hand operated, or may be powered. The drain cleaner 10 includes a rotatable drum 12 which extends through a rear opening 14 at a rear end of a housing 16 for holding an elongated flexible cable or snake 18 which is fed out of the drum 12 and through the housing 16 along a cable feed path 20 and which exits a front end of the housing 16 through a front opening 22. As an example, a twenty-five foot long cable 18 may be provided within the drum 12. The housing 16 is adapted to rotatably support the drum 12, and the drum 12 rotates around a rotational axis RA which is defined through the center of the rear opening 14. A longitudinal axis LA of the housing 16 extends through the center of the front opening 22. The rotational axis RA and the longitudinal axis LA are parallel to each other, but vertically offset from each other; the longitudinal axis LA is vertically below the rotational axis RA. The rotational axis RA defines a first axis and the longitudinal axis LA defines a second axis. A feed clutch assembly 24 is pivotally connected to the housing 16 for selectively engaging the cable 18. A driving assembly 26 is provided for feeding the cable 18 outward from the drum 12, along the cable feed path 20 and out of the front opening 22 upon engagement of the cable 18 by the feed clutch assembly 24 and rotation of the drum 12 in a first direction, and for feeding the cable 18 back into the drum 12 upon engagement of the cable 18 by the feed clutch assembly 24 and rotation of the drum 12 in a second opposite direction. The feed clutch assembly 24 and the driving assembly 26 form a cable feeding and retraction assembly. A portion of the cable 18 is coiled within the drum 12 and a portion of the cable 18 extends from the drum 12. As is conventional, the cable 18 is made of tightly wound spring wire and, in the illustrated embodiment, the spring wire at the free or outer end thereof is formed to provide an auger tip 28 which is radially enlarged relative to the remainder of the cable 18. The structure of the drain cleaner 10 ensures that the cable 18 does not bend within the drain cleaner 10 as the cable 18 moves along the cable feed path 20. The diameter of the front opening 22 is smaller than the auger tip 28 such that the whole of the cable 18 cannot be wound back into the drum 12.

The rotatable drum 12 includes a first drum part 30, a second drum part 32 removably connected to the first drum part 30, and a crank handle 34 extending from the first drum part 30. The first drum part 30 has a rear end wall 36 from which a circular side wall 38 extends forwardly. The second drum part 32 has a front end wall 40 from which a circular side wall 42 extends rearwardly and from which a drive shaft 44 extends forwardly. The ends of the side walls 38, 42 abut and engage each other to form a cavity 46 in which the cable 18 is coiled. The front end wall 40 is conical. The drive shaft 44 is centrally located on the second drum part 32 at the smallest diameter of the cone formed by the front end wall 40. The drive shaft 44 extends from the conical front end wall 40 and includes a cylindrical portion 48 which defines an elongated cylindrical passageway portion 50 extending from a center of the cavity 46 and a front conical portion 52 which defines a conical passageway portion 54 extending from the cylindrical passageway portion 50. The smallest diameter of the cone formed by the front conical portion 52 is at the connection to the cylindrical portion 48. The rotational axis RA coincides with a longitudinal axis of the drive shaft 44. The cable 18 is received into the cylindrical passageway portion 50 from the cavity 46 of the drum 12 and extends therethrough and into and through the conical passageway portion 54. The drive shaft 44 is preferably integrally formed with the second drum part 32. The crank handle 34 extends rearwardly from the rear end wall 36 and rotates with the drum 12. The crank handle 34 extends parallel to the rotational axis RA and may be rotatable around its axis relative to the second drum part 32.

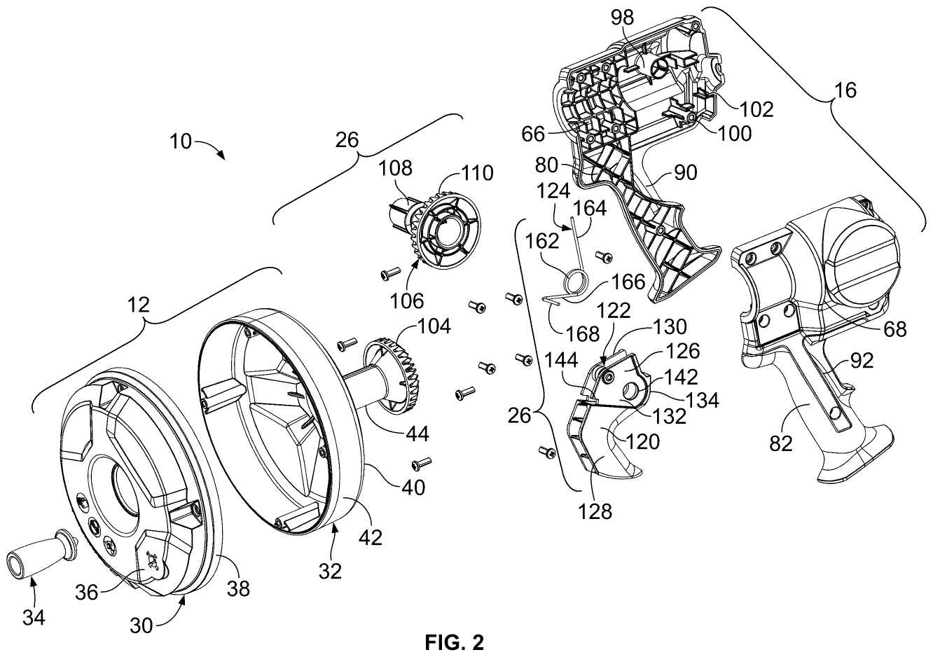

The housing 16 includes a body portion 56 and a handle portion 58 extending downwardly therefrom. The housing 16 may be formed as two separate parts as shown in FIG. 2 which are affixed together.

The body portion 56 has opposite rear and front walls 60, 62, and top and opposite side walls 64, 66, 68 extending therebetween. The walls 60, 62, 64, 66, 68 may form a barrel-shape and define a cavity 70. The rear opening 14 is provided through the rear wall 60 and is open to the cavity 70. The rear opening 14 is sized slightly larger than the diameter of the cylindrical portion 48 of the drive shaft 44. The front opening 22 is provided through the front wall 62 and is open to the cavity 70. The front opening 22 is sized slightly larger than the diameter of the spring wire of the cable 18 and smaller than the auger tip 28. The handle portion 58 is positioned towards the center of gravity of the drain cleaner 10 and supports the entire weight of the drain cleaner 10 in use.

The handle portion 58 is canted relative to the longitudinal axis LA and extends downward from the body portion 56. The handle portion 58 has opposite rear and front walls 72, 74, opposite top and bottom walls 76, 78 extending therebetween, and opposite side walls 80, 82 extending therebetween. The front wall 74 has an upper vertically extending portion 84 which extends downward from the top wall 76, an intermediate portion 86 extending an angle forwardly from the lower end of the upper portion 84, and a lower portion 88 extending an angle forwardly from the lower end of the intermediate portion 86. The rear wall 72 and the lower portion 88 are generally parallel to each other. Each side wall 80, 82 has an extension portion 90, 92 extending forward the upper and intermediate portions 84, 86 of the front wall 74 such that a recess 94 is defined. An opening 96 is defined between the front of the top wall 76 of the handle portion 58 and the lower end of the front wall 62 of the body portion 56. The opening 96 is open to the cavity 70 and to the recess 94. The opening 96 extends parallel to, and is vertically below, the longitudinal axis LA.

The drive shaft 44 extends into the cavity 70 of the housing 16 through the rear opening 14. The drum 12 is rotatably supported by the drive shaft 44.

Each side wall 66, 68 of the body portion 56 has an upper projection 98 extending inwardly therefrom and into the cavity 70. The upper projections 98 extending from each side wall 66, 68 align with each other and the inner ends of each are spaced apart from each other. The upper projections 98 are vertically above the opening 96, are vertically above the longitudinal axis LA, and are spaced from a front end of the drive shaft 44. Centers of the upper projections 98 fall along the rotational axis RA defined by the drum 12.

Each side wall 66, 68 further has a lower projection 100 extending inwardly therefrom and into the cavity 70. The lower projections 100 extending from each side wall 66, 68 align with each other and the inner ends of each are fixedly coupled together. The lower projections 100 are vertically above the opening 96, are vertically below the longitudinal axis LA, and are spaced from the front end of the drive shaft 44. Centers of the lower projections 100 are longitudinally forward of the center of the upper projections 98.

At least one of the side wall 66, 68 further has a stop projection 102 extending inwardly therefrom and into the cavity 70. The stop projection 102 is forward of the lower projections 100 and below the front opening 22. The stop projection 102 extends parallel to the longitudinal axis LA.

The driving assembly 26 includes a first gear 104 surrounding a front end of the front conical portion 52 of the drive shaft 44, and a drive wheel 106 mounted to the body portion 56. The drive wheel 106 includes a shaft 108 having a second gear 110 extending from an end thereof, and which are preferably integrally formed. The first gear 104 is preferable integrally formed with the front conical portion 52 of the drive shaft 44 and is positioned within the cavity 70. The drive wheel 106 is mounted on the projections 98 and extends therebetween within the cavity. The drive wheel 106 is freely rotatably mounted on the upper projections 98. The shaft 108 defines an axis of rotation DRA of the drive wheel 106 which is normal to the rotational axis RA, longitudinally aligned with the rotational axis RA, and is normal to the longitudinal axis LA. In the embodiment as shown, the gear 104 is proximate to the side wall 68. The first and second gears 104, 110 intermesh and form a gearing arrangement. Rotation of the drum 12 causes rotation of the drive wheel 106. The gears 104, 110 may be bevel gears or face gears.

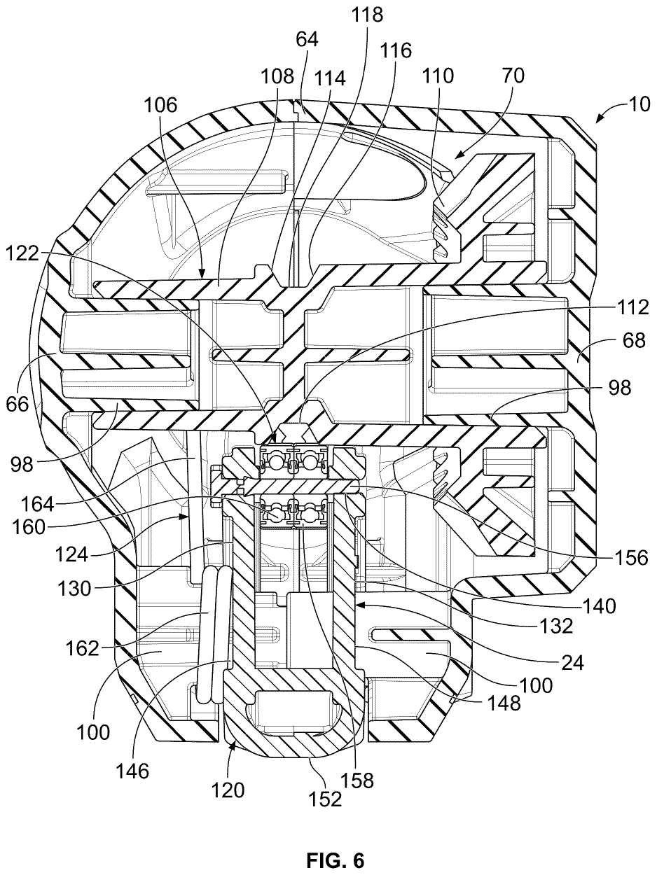

A contoured cable seating groove 112 is provided along the length of the shaft 108 on its outer diameter and extends around the circumference thereof. As examples, the cable seating groove 112 may be trapezoidal to provide a three-point contact with the cable 18, may be formed as a V-shape to provide a two-point contact with the cable 18, may be contoured seat into which the cable seats. The cable seating groove 112 may take the form of a semi-circle. The cable seating groove 112 may have texturing thereon to grip the cable 18. The cable seating groove 112 includes a pair of angled wall surfaces 114, 118 which are joined together by an intermediate wall surface 118. Each angled wall surface 114, 118 angles inward to the intermediate wall surface 118 such the angled wall surfaces 114, 118 are farthest apart at their outer ends which joins with the remainder of the shaft 108, and closest at their ends which joins with the intermediate wall surface 118. As shown in the view of FIG. 6, the angled wall surface 114 extends at a one hundred and twenty degree angle relative to the rotational axis DRA of the drive wheel 106 and the angled wall surface 118 extends at a sixty degree angle relative to the rotational axis DRA of the drive wheel 106. In cross-section, each wall surface 114, 118, 118 is planar. While the cable seating groove 112 is shown as integrally formed with the shaft 108, the cable seating groove 112 can be provided on a separate part and attached to the shaft 108.

The feed clutch assembly 24 includes a depressible actuator member 120 for moving the feed clutch assembly 24 between a non-actuating position and an actuating position, a pinch roller 122 mounted on the actuator member 120, and a spring element 124 mounted on the actuator member 120 and on the housing 16.

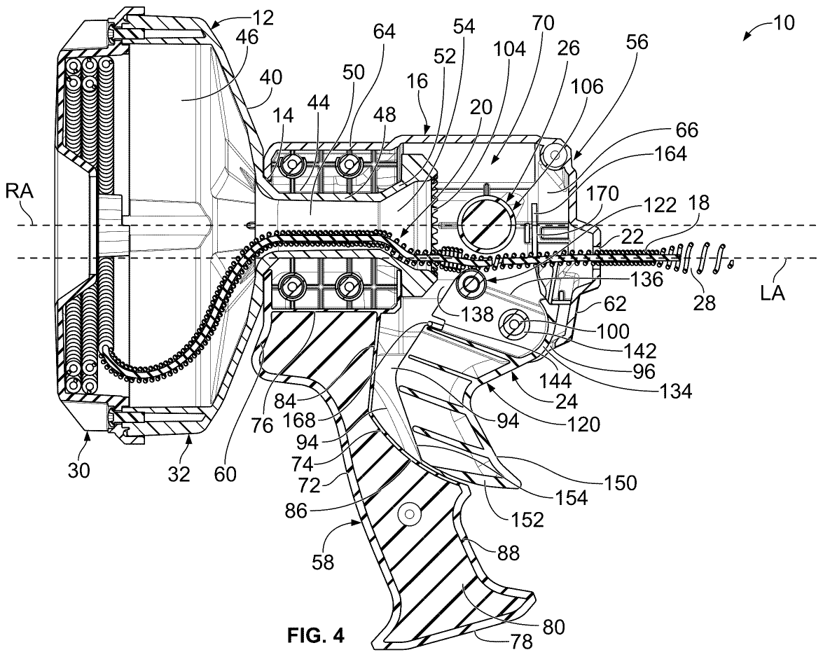

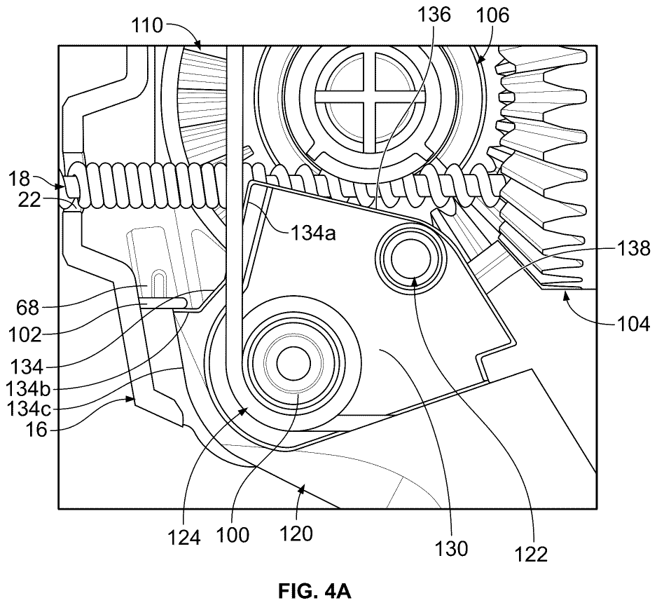

The actuator member 120 is generally L-shaped, and has a main body section 126 and a handle section 128 extending downwardly therefrom. The main body section 126 has a pair of parallel and spaced apart side walls 130, 132 which are coupled together by a front wall 134. Additional reinforcing ribs may be provided to couple the side walls 130, 132 together. Each side wall 130, 132 defines a top surface 136 and a rear surface 138 which are angled relative to each other. The side walls 130, 132 define a cable receiving space therebetween. The front wall 134 has an upper section 134a which is generally perpendicular to the top surfaces 136, an intermediate section 134b extending from a lower end of the upper section 134a and which is generally perpendicular to the upper section 134a and parallel to the top surfaces 136, and a lower section 134c extending from a front end of the intermediate section 134b and which may be curved. A rear opening 140, see FIG. 6, is provided through each side wall 130, 132 proximate to the corner between the top and rear surfaces 136, 138. A front opening 142, see FIG. 2, is provided through each side wall 130, 132 proximate to the corner between the top surface 136 and the front wall 134. A recess 144, see FIGS. 2 and 4, is provided in each rear surface 138 at a lower end of each side wall 130, 132. When the top surface 136 is viewed in a horizontal position with the rear surface 138 viewed in a vertical position, the rear openings 140 are vertically above and rearward of the front openings 142, and the recesses 144 are vertically below the front openings 142. The handle section 128 is generally L-shaped and has a pair of parallel side walls 146, 148 which are coupled together by a front wall 150 and a bottom wall 152. Additional reinforcing ribs may be provided to couple the side walls 146, 148 together. The side wall 146 extends from side wall 130 and side wall 148 extends from side wall 132. The front wall 150 is generally U-shaped and extends from a lower end of the front wall 134. The side walls 146, 148 define a rear surface 154 which extends from a lower end of the rear surface 138. The rear surface 154 is generally L-shaped with an upper portion that is angled relative to a lower portion.

The lower projections 100 extend through the front openings 142 of the actuator member 120 and the main body section 126 is substantially positioned within the cavity 70 of the body portion 56 and extends through the opening 96. The actuator member 120 partially seats within the recess 94 and partially extends outwardly therefrom. The rear surface 154 of the actuator member 120 faces the front wall 74 of the handle portion 58. The actuator member 120 rotates around the lower projections 100.

The pinch roller 122 includes a shaft 156, a smooth cylindrical roller 158 and a plurality of ball bearings 160. The shaft 156 extends through the rear openings 140 and is affixed to the side walls 130, 132 of the actuator member 120. The smooth cylindrical roller 158 freely rotatably mounted on the shaft 156 by the plurality of ball bearings 160 provided between the shaft 156 and the roller 158. The cylindrical roller 158 is smooth and devoid of teeth. The pinch roller 122 extends upward from the top surface 136 of the actuator member 120. The shaft 156 defines a rotational axis PRA of the pinch roller 122 which is normal to the rotational axis RA, is normal to the longitudinal axis LA and is parallel to the rotational axis DRA of the drive wheel 106. The pinch roller 122 rotates with the actuator member 120 around the lower projections 100. The rotational axis PRA is always below the longitudinal axis LA during the movement.

The spring element 124 may take the form of a torsion spring having a central coil 162, a first leg 164 extending from a first end of the coil 162, a second leg 166 extending from a second end of the coil 162, and an engagement 168 extending from an end of the second leg 166. The first and second legs 164, 166 are parallel to each other, but offset from each other. The second leg 166 and the engagement 168 are perpendicular to each other. In an unstressed condition, the first and second legs 164, 166 are generally ninety degrees apart from each other.

A projection which defines a vertical slot 170 extends from the side wall 66. The slot 170 is provided forward of the drive wheel 106, forward of the lower projections 100, and above the longitudinal axis LA. The coil 162 of the spring element 124 is mounted around the lower projection 100 extending from the side wall 66 and abuts against the side wall 146. The first leg 164 extends vertically and seats within the vertical slot 170. The second leg 166 extends rearward from the lower projection 100 and the engagement 168 seats within the recess 144 of the actuator member 120.

In the non-actuating position of the drain cleaner 10 as shown in FIGS. 4 and 4A, the spring element 124 is placed into a prestressed position and the first and second legs 164, 166 are generally sixty degrees apart from each other. The intermediate section 134b of the actuator member 120 engages against the stop projection 102 and a space is provided within the recess 94 between the upper and intermediate portions 84, 86 of the front wall 74 of the handle portion 58 and the actuator member 120. A user cannot touch the moving parts within the body portion 56 since the opening 142 is blocked by the actuator member 120. The rotational axis PRA of the pinch roller 122 is offset rearward of the rotational axis DRA of the drive wheel 106, and the pinch roller 122 is offset longitudinally rearward from the cable seating groove 112 such that a clearance space, which is greater than the diameter of the cable 18, is provided between the pinch roller 122 and the drive wheel 106. The cable feed path 20 is provided between the pinch roller 122 and the cable seating groove 112 through which the cable 18 extends. As shown in FIG. 4A, the cable 18 partially seats within the cable receiving space defined by the side walls 130, 132 of the actuator member 120. This aligns the cable 18 with the cable seating groove 112 when in the non-actuating position of the drain cleaner 10. The cable 18 may be slack within the cable feed path 20 and rest on the pinch roller 122.

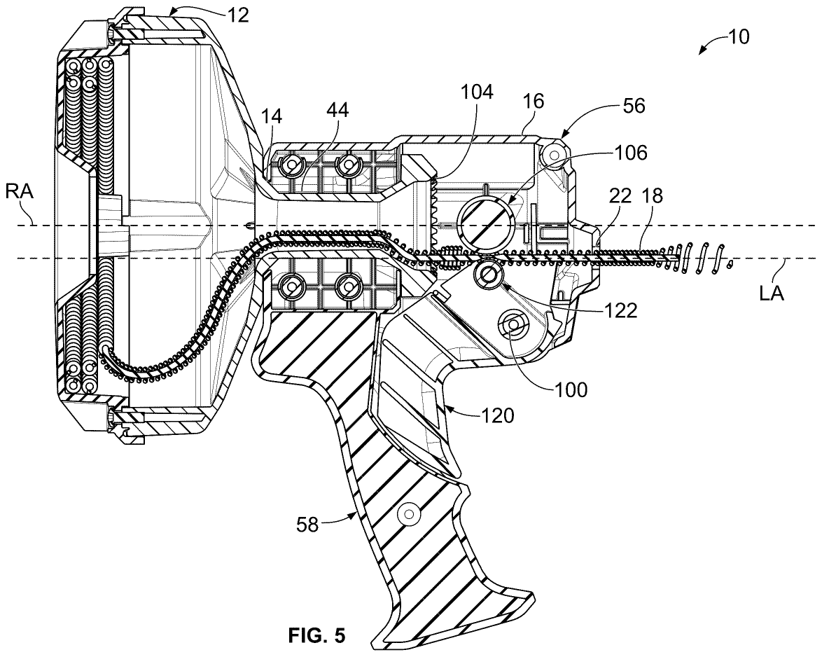

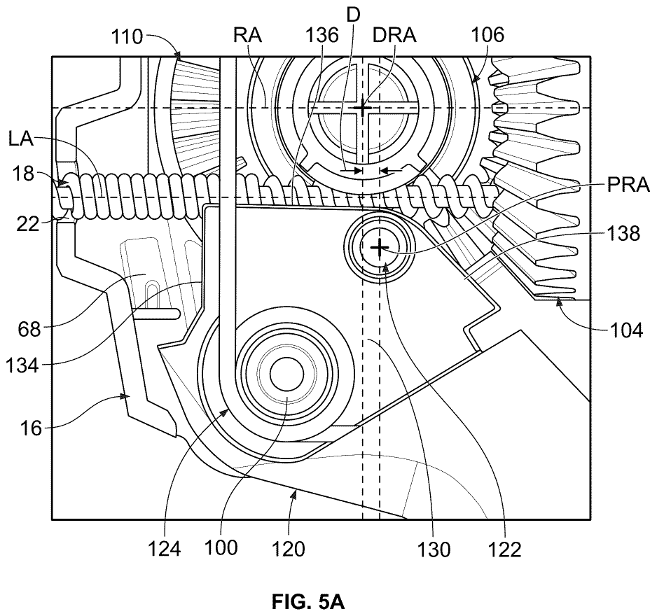

To move the drain cleaner 10 to the actuating position, the user places his/her hand around the handle portion 58 and depresses the actuator member 120 toward the handle portion 58 which pivots the actuator member 120, and thus the pinch roller 122, around the lower projections 100 to actuate the feed clutch assembly 24. The rotational axes DRA, PRA of the drive wheel 106 and the pinch roller 122 remain offset from each other, shown by distance D in FIG. 5A. The cable seating groove 112 is partially vertically above the pinch roller 122 and a cable receiving space is defined which forms part of the cable feed path 20. A center of the cable receiving space aligns with the longitudinal axis LA. This causes the intermediate section 134b of the actuator member 120 to move away from the stop projection 102, and the first and second legs 164, 166 of the spring element 124 to move toward each other. The pinch roller 122 moves vertically upward within the cavity 70 of the body portion 56 and engages the cable 18 against the drive wheel 106, but does not move past the longitudinal axis LA. As shown in FIG. 5A, more of the cable 18 partially seats within the cable receiving space defined by the side walls 130, 132 of the actuator member 120. The tightly wound spring wire which forms the cable 18 is clamped or pinched between the drive wheel 106 and the pinch roller 122, but because the pinch roller 122 is a smooth cylinder, the cable 18 is not damaged when the cable 18 is pinched. The offset shown by distance D reduces wear of the drive wheel 106 during movement of the cable 18. When the user releases the actuator member 120, the spring element 124 resumes its prestressed position, rotating the actuator member 120 and pinch roller 122 away from the handle portion 58 to engage the intermediate section 134b of the actuator member 120 with the stop projection 102.

A portion of the cable 18 is coiled within the drum 12. To feed the portion of the cable 18 out of the drum 12 and through the front opening 22 when the drain cleaner 10 is in the actuating position, the crank handle 34 is rotated to rotate the drum parts 30, 32, the drive shaft 44 and the first gear 104, which in turn rotates the second gear 110 and the shaft 108. For example, the drum 12 is rotated in the clockwise direction. The frictional engagement between the cable 18, the pinch roller 122 and the cable seating groove 112 of the shaft 108 causes the cable 18 to advance axially out of the drain cleaner 10. The support provided to the cable 18 by the pinch roller 122 ensures a smooth rotation of the drum 12 and the user can feel the cable advancement out of the housing 16. The partial capture of the cable 18 between the side walls 130, 132 of the actuator member 120 aligns the cable 18 with the front opening 22 and assists in the proper advancement of the cable 18. Also, since the front end wall 40 of the drum 12 is conical, coil tension of the cable 18 at the exit of the drum 12 is relieved so as to prevent the cable 18 from bending within the drum 12. The front opening 22, which forms the cable exit opening from the housing 16, is offset from the rotational axis RA of the drum 12 and provides smooth movement of the cable 18 without bending within the housing 16.

To feed the cable back into the drum 12 through the front opening 22 when the drain cleaner 10 is in the actuating position, the crank handle 34 is rotated in the opposite direction to counterrotate the drum parts 30, 32, the drive shaft 44 and first gear 104, which in turn counterrotates the second gear 110 and the shaft 108. For example, the drum 12 is rotated in the counterclockwise direction. The frictional engagement between the cable 18, the pinch roller 122 and the cable seating groove 112 of the shaft 108 causes the cable 18 to retract axially back into the drain cleaner 10. Again, the support provided to the cable 18 by the pinch roller 122 ensures a smooth rotation of the drum 12, the user can feel the cable retraction into the housing 16, and the coil tension of the cable 18 at the exit of the drum 12 is relieved so as to prevent the cable 18 from bending within the drum 12. Again, the partial capture of the cable 18 between the side walls 130, 132 of the actuator member 120 aligns the cable 18 with the front opening 22 and assists in the proper retraction of the cable 18.

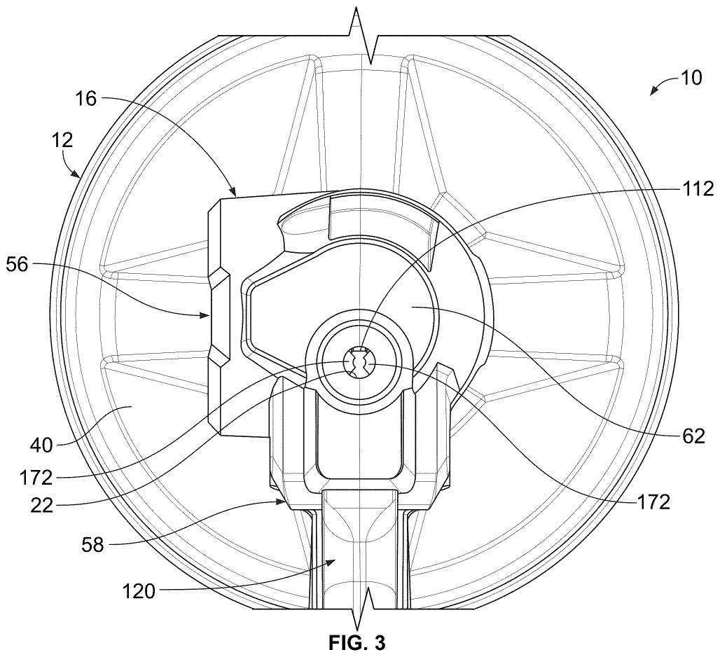

As shown in FIG. 3, a pair of frangible housing wall sections 172 extend into the front opening 22 and partially block the front opening 22. Prior to use, the auger tip 28 of the tightly wound spring wire of the cable 18 seats on either side of the frangible housing wall sections 172. This prevents the cable 18 from exiting through the front opening 22 during initial transport to the customer. When the drain cleaner 10 is moved to the actuating position and the drum is rotated, the frangible housing wall sections 172 break off such that there is no impediment to the movement of the cable 18 through the front opening 22. The frangible housing wall sections 172 may not be provided.

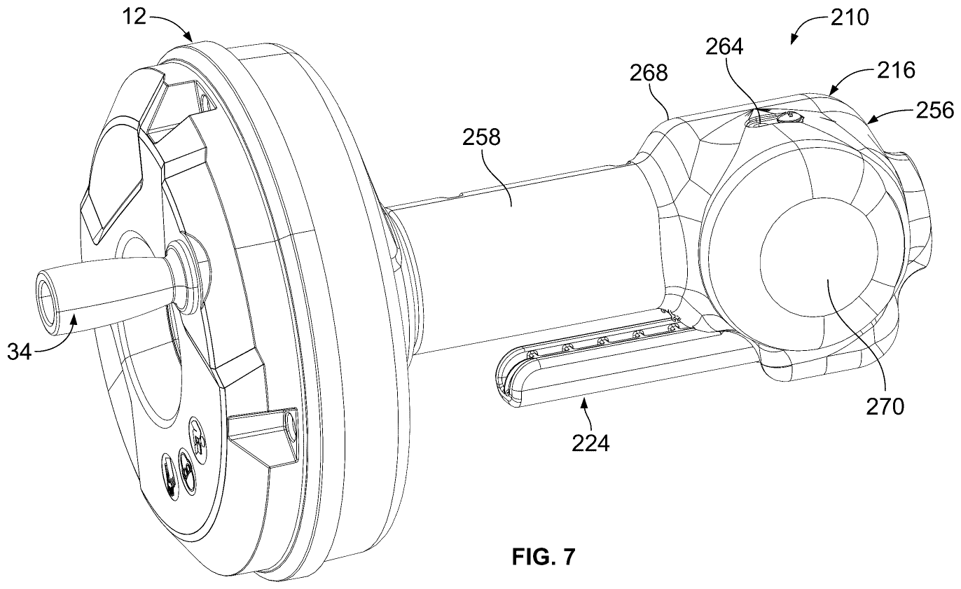

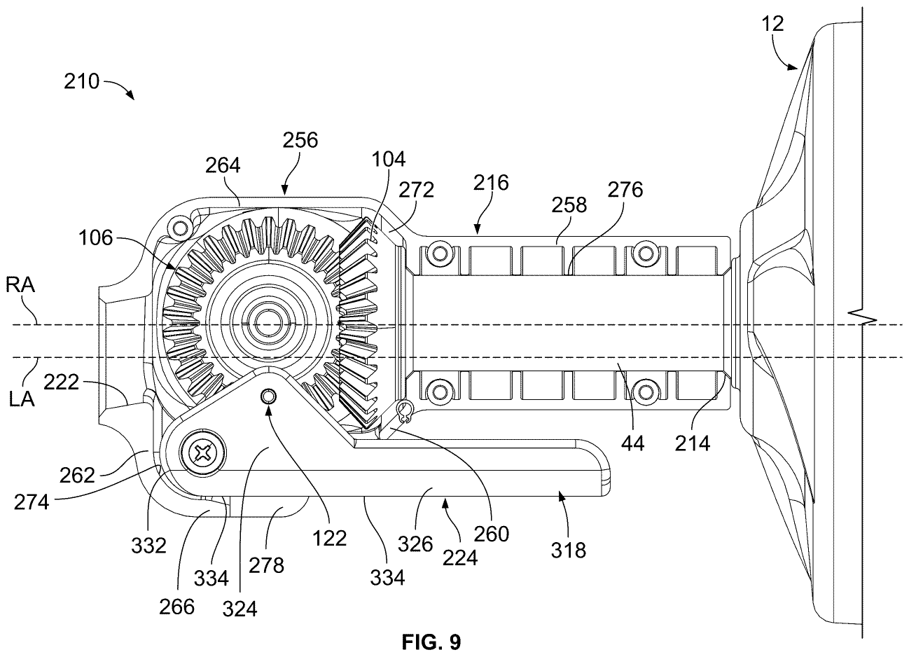

FIGS. 7-9 illustrate a second embodiment of the drain cleaner 210 which holds the elongated flexible cable or snake 18 (not shown in this embodiment). The drain cleaner 210 includes the rotatable drum 12, the driving assembly 26, and the pinch roller 122 shown in the first embodiment. The specifics of these components are not repeated herein.

The drum 12 extends through a rear opening 214 at a rear end of a housing 216 for holding the elongated flexible cable or snake 18 which is fed out of the drum 12 and through the housing 216 along a cable feed path and which exits a front end of the housing 216 through a front opening 222. As an example, a twenty-five foot long cable 18 may be provided within the drum 12. The housing 216 is adapted to rotatably support the drum 12, and the drum 12 rotates around a rotational axis RA which is defined through the center of the rear opening 214. A longitudinal axis LA of the housing 216 extends through the center of the front opening 222. The rotational axis RA and the longitudinal axis LA are parallel to each other, but vertically offset from each other; the longitudinal axis LA is vertically below the rotational axis RA. The rotational axis RA defines a first axis and the longitudinal axis LA defines a second axis. A feed clutch assembly 224 is pivotally connected to the housing 216 for selectively engaging the cable 18. The driving assembly 26 feeds the cable 18 outward from the drum 12, along the cable feed path and out of the front opening 222 upon engagement of the cable 18 by the feed clutch assembly 224 and rotation of the drum 12 in a first direction, and for feeding the cable 18 back into the drum 12 upon engagement of the cable 18 by the feed clutch assembly 224 and rotation of the drum 12 in a second opposite direction.

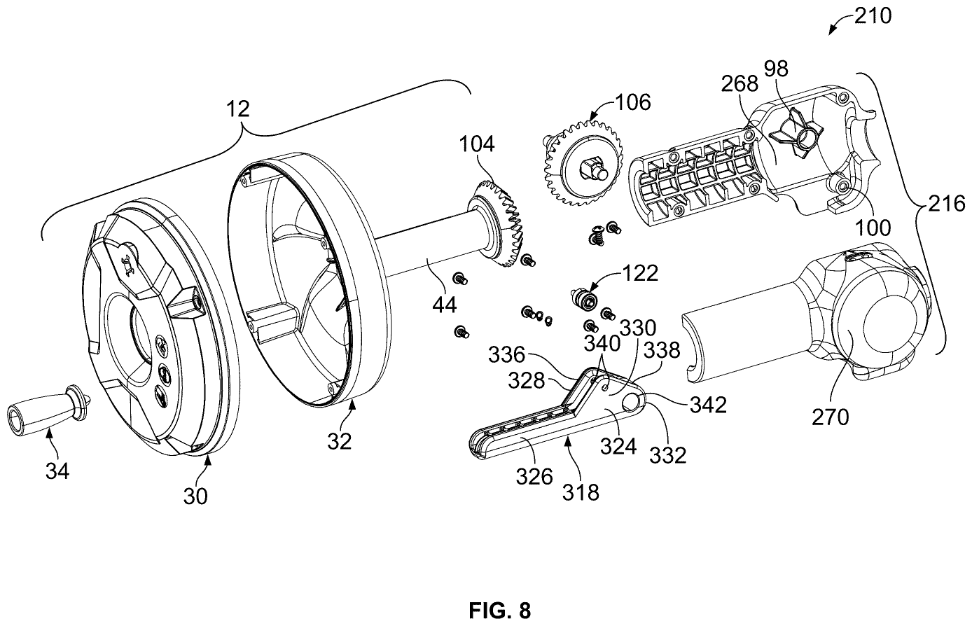

The housing 216 may be formed as two separate parts as shown in FIG. 8 which are affixed together. The housing 216 includes a front body portion 256 and a cylindrical rear portion 258 extending from a rear end of the front body portion 256. The front body portion 256 has opposite rear and front walls 260, 262, a top wall 264 extending therebetween, a bottom wall 266 extending from the front wall 262, and opposite side walls 268, 270 extending therebetween. The walls 260, 262, 264, 266, 268, 270 may form a box-like shape and define a cavity 272. The inner surface 274 of the corner between the front wall 262 and the bottom wall 266 is curved. The rear opening 214 is provided through the rear end of the rear portion 258 and is open to an elongated passageway 276 through the rear portion 258. The passageway 276 is open to the cavity 272. The rear opening 214 is sized slightly larger than the diameter of the cylindrical portion 48 of the drive shaft 44. The front opening 222 is provided through the front wall 262 and is open to the cavity 272. The front opening 222 is sized slightly larger than the diameter of the spring wire of the cable 18 and smaller than the auger tip 28. An opening 278 is provided through the bottom wall 266 and is open to the cavity 272. The opening 278 extends parallel to, and is vertically below, the longitudinal axis LA. Each side wall 268, 270 has the upper and lower projections 98, 100 positioned on the side walls 268, 270 in an identical manner to the first embodiment, and the specifics are not repeated herein.

The drive shaft 44 extends into the cavity 272 through the rear opening 214. The drum 12 is rotatably supported by the drive shaft 44.

The feed clutch assembly 224 includes a depressible actuator member 318 for moving the feed clutch assembly 224 between a non-actuating position and an actuating position, and the pinch roller 122 mounted on the actuator member 318.

The actuator member 318 has a main body section 324 and an elongated handle section 326 extending therefrom. The main body section 324 has a pair of parallel, triangularly shaped side walls 328, 330 which are coupled together by a curved front wall 332 and a bottom wall 334. Additional reinforcing ribs may be provided to couple the side walls 328, 330 together. The side walls 328, 330 define a rear top surface 336 and a front top surface 338 which are generally perpendicular to each other. While the spring element 124 is not shown with regard to this embodiment, the spring element 124 is provided between the housing 216 and the depressible actuator member 318 to bias the depressible actuator member 318 into the non-actuating position in the same manner as provided for in the first embodiment.

A rear opening 340, see FIG. 8, is provided through each side wall 328, 330 proximate to the corner between the top surfaces 336, 338. A front opening 342, see FIG. 8, is provided through each side wall 328, 330 proximate to the curved front wall 332. When the bottom surface 334 is viewed in a horizontal position, the rear openings 340 are vertically above and rearward of the front openings 342.

The lower projections 100 extend through the front openings 342 of the actuator member 318 and the main body section 324 is substantially positioned within the cavity 272 of the body portion 256 and extends through the opening 278. The main body section 324 partially seats within the cavity 272 and partially extends outwardly therefrom. The front surface 332 of the actuator member 318 engages with the curved inner surface 274. The actuator member 120 rotates around the lower projections 100. The pinch roller 122 seats within the rear openings 340.

In the non-actuating position of the drain cleaner 210, the handle section 326 of the actuator member 318 is at an angle relative to the longitudinal axis LA and the rotational axis RA. A user cannot touch the moving parts within the body portion 256 since the opening 278 is blocked by the actuator member 318. The rotational axis of the pinch roller 122 is rearward of the rotational axis of the drive wheel 106, and the pinch roller 122 is offset longitudinally rearward from the cable seating groove 112 such that a clearance space is provided between the pinch roller 122 and the drive wheel 106. The cable feed path is provided between the pinch roller 122 and the cable seating groove 112 through which the cable 18 extends, but the cable 18 may be slack within the cable feed path and rest on the pinch roller 122.

To move the drain cleaner 210 to the actuating position, the user places his/her hand around the handle portion 258 and depresses the handle section 326 of the actuator member 318 toward the handle portion 258 which pivots the actuator member 318, and thus the pinch roller 122, around the lower projections 100 to actuate the feed clutch assembly 24. The handle section 326 of the actuator member 318 is parallel to, or substantially parallel to, the longitudinal axis LA and the rotational axis RA. The rotational axes of the drive wheel 106 and the pinch roller 122 may vertically align, and the cable seating groove 112 is vertically above the pinch roller 122 and a cable receiving space is defined which forms part of the cable feed path. The cable receiving space aligns with the front opening 222, and a center of the cable receiving space aligns with the longitudinal axis LA. The pinch roller 122 moves vertically upward within the cavity 272 of the body portion 256 and engages with the cable 18, but does not move past the longitudinal axis LA. The tightly wound spring wire which forms the cable 18 is clamped or pinched between the drive wheel 106 and the pinch roller 122, but because the pinch roller 122 is a smooth cylinder, the cable 18 is not damaged when the cable 18 is pinched. The cable 18 partially seats within the cable receiving space defined by the side walls 328, 330 of the actuator member 318 which aligns the cable 18 with the cable seating groove 112 when in the non-actuating position of the drain cleaner 210. When the user releases the actuator member 318, the pinch roller 122 rotates away from the drive wheel 106 under the bias of the spring element.

A portion of the cable 18 is coiled within the drum 12. To feed the portion of the cable 18 out of the drum 12 and through the front opening 222 when the drain cleaner 210 is in the actuating position, the crank handle 34 is rotated to rotate the drum parts 30, 32, the drive shaft 44 and the first gear 104, which in turn rotates the second gear 110 and the shaft 108. For example, the drum 12 is rotated in the clockwise direction. The frictional engagement between the cable 18, the pinch roller 122 and the cable seating groove 112 of the shaft 108 causes the cable 18 to advance axially out of the drain cleaner 210. The support provided to the cable 18 by the pinch roller 122 ensures a smooth rotation of the drum 12 and the user can feel the cable advancement out of the housing 216. Since the front end wall 40 of the drum 12 is conical, coil tension of the cable 18 at the exit of the drum 12 is relieved so as to prevent the cable 18 from bending within the drum 12. The front opening 222, which forms the cable exit opening from the housing 216, is offset from the rotational axis RA of the drum 12 and provides smooth movement of the cable 18 without bending within the housing 216.

To feed the cable back into the drum 12 through the front opening 222 when the drain cleaner 210 is in the actuating position, the crank handle 34 is rotated in the opposite direction to counterrotate the drum parts 30, 32, the drive shaft 44 and first gear 104, which in turn counterrotates the second gear 110 and the shaft 108. For example, the drum 12 is rotated in the counterclockwise direction. The frictional engagement between the cable 18, the pinch roller 122 and the cable seating groove 112 of the shaft 108 causes the cable 18 to retract axially back into the drain cleaner 210. Again, the support provided to the cable 18 by the pinch roller 122 ensures a smooth rotation of the drum 12, the user can feel the cable retraction into the housing 216, and the coil tension of the cable 18 at the exit of the drum 12 is relieved so as to prevent the cable 18 from bending within the drum 12.

The frangible housing wall sections 172 shown in the first embodiment may also be provided in the drain cleaner 210.

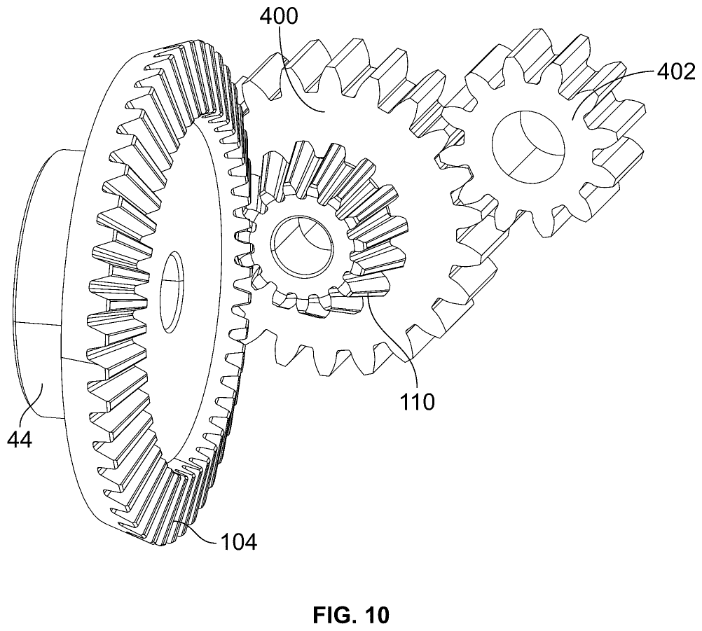

FIG. 10 illustrates an alternate gearing arrangement which can be provided within the drain cleaner 10, 210. The gearing arrangement of FIG. 10 includes the first and second gears 104, 110, but the second gear 110 is not mounted on the end of the shaft 108 and instead is fixedly mounted on a spur gear 400 which is rotatably mounted on a shaft (not shown) extending from the side wall 66, 268. The second gear 110 and the spur gear 400 form a combination gear. The gearing arrangement of FIG. 10 further includes spur gear 402 which is rotatably mounted on a shaft (not shown) extending from the side wall 66, 268. The shaft 108 is fixedly coupled to the spur gear 402 and rotates therewith. The spur gears 400, 402 are intermeshed. Rotation of the drum 12 and thereby rotation of the drive shaft 44, causes rotation of the second gear 110 as a result of the interengagement of the first and second gears 104, 110. The spur gear 400 rotates with the second gear 110, and causes rotation of the spur gear 110 and the shaft 108.

The gear ratio provided by the first and second gears 104, 110 (and the spur gears 400, 402 if provided), and the number of rotations of the drum 12 defines the amount of time to feed the cable 18 out of the housing 16, 216 and to reverse the cable 18 back into the drum 12. As a result, a rapid feeding of the cable 18 out of the drum 12 can be achieved.

The drain cleaner 10, 210 is made from a minimal number of parts in order to reduce the cost of manufacture. All of the components of the drain cleaner 10, 210 may be formed of injection molded plastic, however, in order to reduce wear, some parts may be made of metal.

While a particular embodiment is illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims.

What is claimed is:

1. A handheld drain cleaner which feeds out and retracts a flexible cable for use in cleaning a drain, comprising:
a housing defining a cavity and having a rear opening and a front opening extending from the cavity, wherein a center of the rear opening defines a first axis and a center of the front opening defines a second axis, the first and second axes being parallel to each other and offset from each other, the second axis being vertically below the first axis;
a drum coupled to the housing, the drum being rotatable relative to the housing about the first axis, wherein a portion of the flexible cable is within the drum;
a feed clutch assembly connected to the housing for selectively engaging the flexible cable within the cavity in the housing, wherein the feed clutch assembly is movable between a non-actuating position and an actuating position; and
a driving assembly provided on the drum and within the housing, the driving assembly being engageable with the flexible cable upon movement of the feed clutch assembly, and
wherein a feed path is defined through the rear opening, between the feed clutch assembly and the driving assembly and through the front opening,
wherein the flexible cable can be advanced out of the drum, along the feed path and out of the housing upon engagement of the feed clutch assembly with the driving assembly and rotation of the drum in a first direction, and wherein the flexible cable can be retracted into the drum along the feed path upon engagement of the feed clutch assembly with the driving assembly and rotation of the drum in a second, opposite direction.

2. The handheld drain cleaner of claim 1, wherein the driving assembly includes a first gear extending from a front end of the drum, and a second gear rotatably mounted on the housing, the first and second gears being coupled together.

3. The handheld drain cleaner of claim 2, wherein the drum includes a conical front end wall, a side wall extending rearwardly therefrom, and a rear end wall which define a drum cavity, wherein an opening is provided through a center of the conical front end wall through which the flexible cable exits or enters the drum cavity.

4. The handheld drain cleaner of claim 3, wherein the drum includes an elongated shaft extending from the conical front end wall on which the first gear is provided, wherein the cable passes through a passageway formed by the elongated shaft.

5. The handheld drain cleaner of claim 1, wherein the driving assembly includes a first gear extending from a front end of the drum, a second gear rotatably mounted on the housing, and a third gear rotatably mounted on the housing, the first and second gears being coupled together, and the second and third gears being coupled together.

6. The handheld drain cleaner of claim 5, wherein the drum includes a conical front end wall, a side wall extending rearwardly therefrom, and a rear end wall which define a drum cavity, wherein an opening is provided through a center of the conical front end wall through which the flexible cable exits or enters the drum cavity.

7. The handheld drain cleaner of claim 6, wherein the drum includes an elongated shaft extending from the conical front end wall on which the first gear is provided, wherein the cable passes through a passageway formed by the elongated shaft.

8. The handheld drain cleaner of claim 1, wherein the drum includes a conical front end wall, a side wall extending rearwardly therefrom, and a rear end wall which define a drum cavity, wherein an opening is provided through a center of the conical front end wall through which the flexible cable exits or enters the drum cavity.

9. The handheld drain cleaner of claim 1, wherein the feed clutch assembly includes a depressible actuator member which is pivotally attached to the housing, and a pinch roller rotatably mounted on the actuator member, wherein the actuator member is depressed to move the pinch roller proximate to the driving assembly to pinch the cable between the pinch roller and the driving assembly and place the feed clutch assembly into the actuating position.

10. The handheld drain cleaner of claim 9, wherein the feed clutch assembly further includes a spring element coupled to the housing and the actuator member to move the feed clutch assembly into the non-actuating position, wherein the spring element biases the actuator member such that the pinch roller is distant from the driving assembly and the cable is not pinched between the pinch roller and the driving assembly.

11. The handheld drain cleaner of claim 9, wherein the actuator member passes through an opening in the housing and blocks access into an interior of the housing in the actuating position and in the non-actuating position.

12. The handheld drain cleaner of claim 9, wherein the pinch roller is below the second axis.

13. The handheld drain cleaner of claim 12, wherein the driving assembly includes a drive wheel rotatably mounted on the housing, wherein a rotational axis of the drive wheel is longitudinally aligned with the first axis, and the pinch roller is rearward of the drive wheel when in the feed clutch assembly is in the non-actuating position and when the feed clutch assembly is in the actuating position.

14. The handheld drain cleaner of claim 13, wherein the pinch roller is a smooth cylindrical roller and the drive wheel includes a contoured groove into which the cable seats.

15. The handheld drain cleaner of claim 13, wherein the depressible actuator member includes a pair of spaced apart side walls, the pinch roller being positioned between the side walls, and wherein the cable is configured to partially seat between the side walls in the actuating position and in the non-actuating position.

16. The handheld drain cleaner of claim 13, wherein the drum includes a conical front end wall, a side wall extending rearwardly therefrom, and a rear end wall which define a drum cavity, wherein an opening is provided through a center of the conical front end wall through which the flexible cable exits or enters the drum cavity.

17. The handheld drain cleaner of claim 13, wherein the driving assembly includes a gearing arrangement which includes one or more of bevel or face gears and spur gears between a front end of the drum and the drive wheel.

18. The handheld drain cleaner of claim 9, wherein the depressible actuator member includes a pair of spaced apart side walls, the pinch roller being positioned between the side walls, and wherein the cable is configured to partially seat between the side walls in the actuating position.

19. The handheld drain cleaner of claim 9, wherein the drum includes a conical front end wall, a side wall extending rearwardly therefrom, and a rear end wall which define a drum cavity, wherein an opening is provided through a center of the conical front end wall through which the flexible cable exits or enters the drum cavity.

20. The handheld drain cleaner of claim 9, wherein the housing has frangible housing wall sections extending into the front opening.
